(19) United States
(12) Patent Application Publication
(10) Pub. No.: US 2010/0263512 A1
(43) Pub. Date: Oct. 21, 2010

(54) CUTTING TOOL

(76) Inventor: Charlie ZHANG, Oak Brook, IL (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/561,099

(22) Filed: Sep. 16, 2009

Related U.S. Application Data
(60) Provisional application No. 61/169,611, filed on Apr. 15, 2009.

(51) Int. Cl. B26D 1/08; B26D 5/16

(52) U.S. Cl. 83/628; 83/697

(57) ABSTRACT

A cutting tool for cutting sheets of materials, such as, for example, sheets of building materials. The cutting tool includes a base, a support connected to the base and a cam with an increasing radius is positioned over a portion of the base and pivotally connected to the support. The cutting tool further includes a blade holder and blade which are engaged with the cam and positioned over the base. The blade holder and the blade are moveable between an open position and a closed position or cutting position by pivoting the cam.

### CROSS REFERENCE TO RELATED APPLICATION

This application claims the benefit of U.S. provisional patent application, Ser. No. 61/169,611, filed on 15 Apr. 2009. This co-pending provisional patent application is hereby incorporated by reference herein in its entirety and is made a part hereof, including but not limited to those portions which specifically appear hereinafter.

### BACKGROUND OF THE INVENTION

1. Field of the Invention

This invention relates to a cutting tool for cutting sheets of material, such as, for example, sheets of building materials. More specifically, this invention relates to a cutting tool including a base, a pair of supports, a cam pivotally connected to the pair of supports, and a blade holder and a blade positioned between the cam and the base, where the blade holder and the blade are movable between an open position and a closed position by pivoting the cam.

2. Discussion of Related Art

Certain building materials, such as, for example, flooring materials and siding, are provided as sheets or planks of various dimensions. When used on a job site, the sheets or planks must be customized to meet the specific requirements of the job site. For example, the sheets or planks must be cut to fit around edges or corners of a room and/or around fixtures. Various tools are currently used to cut sheets of building materials, but most are bulky, heavy, require power to be operated, produce large amounts of dust during the cutting process, and/or result in uneven or splintered cuts.

There is a need or a desire for an improved cutting tool for cutting sheets or planks of building materials. There is a need or a desire for a portable, non-power operated cutting tool able to cut sheets of building materials in a predictable and straight fashion without splintering, cracking or similar problems and providing fast, dust-free cutting.

### SUMMARY OF THE INVENTION

The present invention provides a portable, non-power operated cutting tool for cutting sheets of building materials that cuts sheets of building materials in a straight fashion without splintering or cracking.

According to an embodiment of this invention, the cutting tool includes a base and a support connected to the base. A cam with an increasing radius is positioned over a portion of the base and pivotally connected to the support. A blade holder, with a blade, is engaged with the cam and is positioned over the base. A handle can be connected to the cam to assist in rotating the cam. The blade holder and the blade are moveable between an open position and a closed position by pivoting the cam. In the open position, the cam contacts the blade holder at a relatively small radius, as the cam rotates, the blade holder contacts the cam at a gradually increasing radius until the blade holder and the blade are in a closed position.

According to a preferred embodiment, as the blade holder travels from the open position to the closed position, the blade holder is maintained in a generally straight path by a guide pin or a pair of guide pins. The guide pin is rigidly connected to the blade holder and passes through a hole in the support and/or the base. The hole is of a similar diameter as the guide pin so that the path of travel of the blade holder is generally straight providing a consistent and repeatable cutting motion. In a preferred embodiment, a spring is positioned between the support and the blade holder and in proximity to the guide pin. The spring biases the blade holder in the open position and as the blade holder travels downward, the spring is compressed to further urge a uniform cut of the blade through the material.

According to an embodiment of this invention, the base defines a support surface and preferably includes a base extension extending beneath at least a portion of the support surface. The base may further include at least one support member, for example a leg and/or a foot for supporting the base before and during cutting. In a preferred embodiment the leg and/or the foot are adjustable to compensate for an uneven ground surface.

### BRIEF DESCRIPTION OF THE DRAWINGS

FIG. 1 is a perspective view of a cutting tool in an open position according to one embodiment of this invention;

FIG. 2 is a perspective view of the cutting tool shown in FIG. 1 shown with a sheet of material;

FIG. 3 is a perspective view of the cutting tool shown in FIG. 1 in a closed position, shown with a sheet of material;

FIG. 4 is a side view of the cutting tool shown in FIG. 1;

FIG. 5 is a side view of the cutting tool shown in FIG. 1, with both a handle and a base extended;

FIG. 6 is a perspective view of the cutting tool shown in FIG. 1 in an open position with a support and a guide pin removed;

FIG. 7 is a perspective view of the cutting tool shown in FIG. 1 in a closed position with the support and guide pin removed;

FIG. 8 is a bottom view of the cutting tool shown in FIG. 1;

FIG. 9 is a cross-section view of the cutting tool shown in FIG. 2 along line 9-9; and

FIG. 10 is a cross-section view of the cutting tool shown in FIG. 3 along line 10-10.

### DESCRIPTION OF THE INVENTION

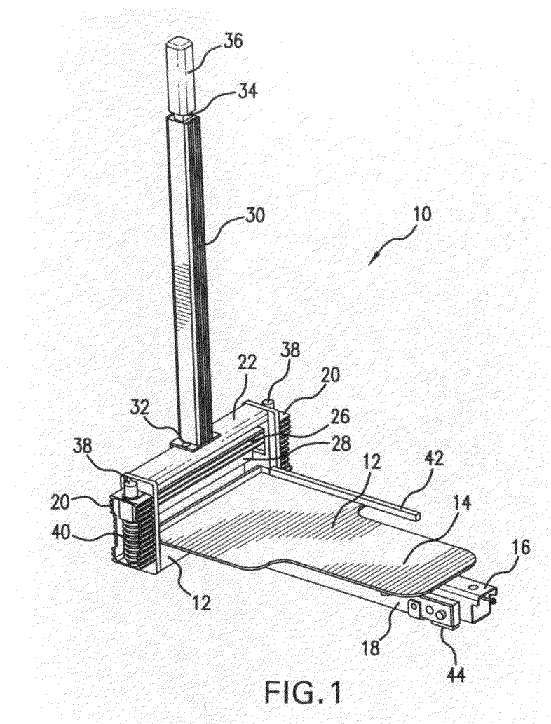

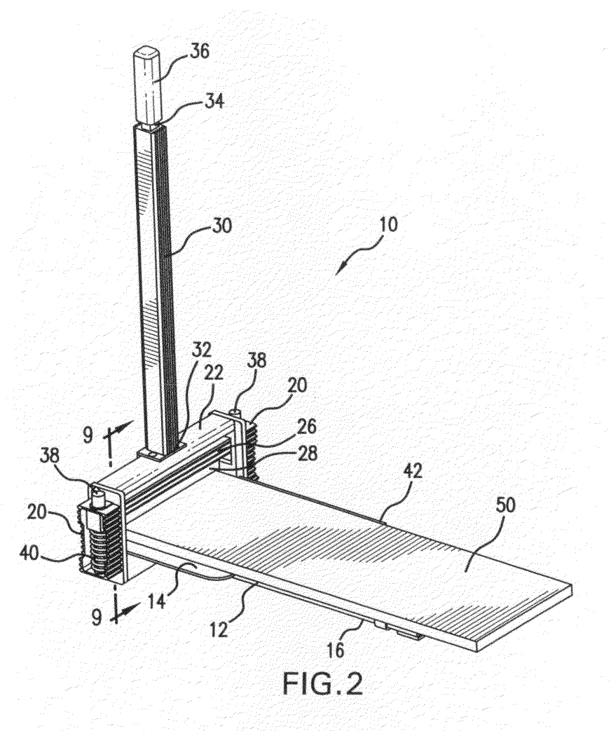

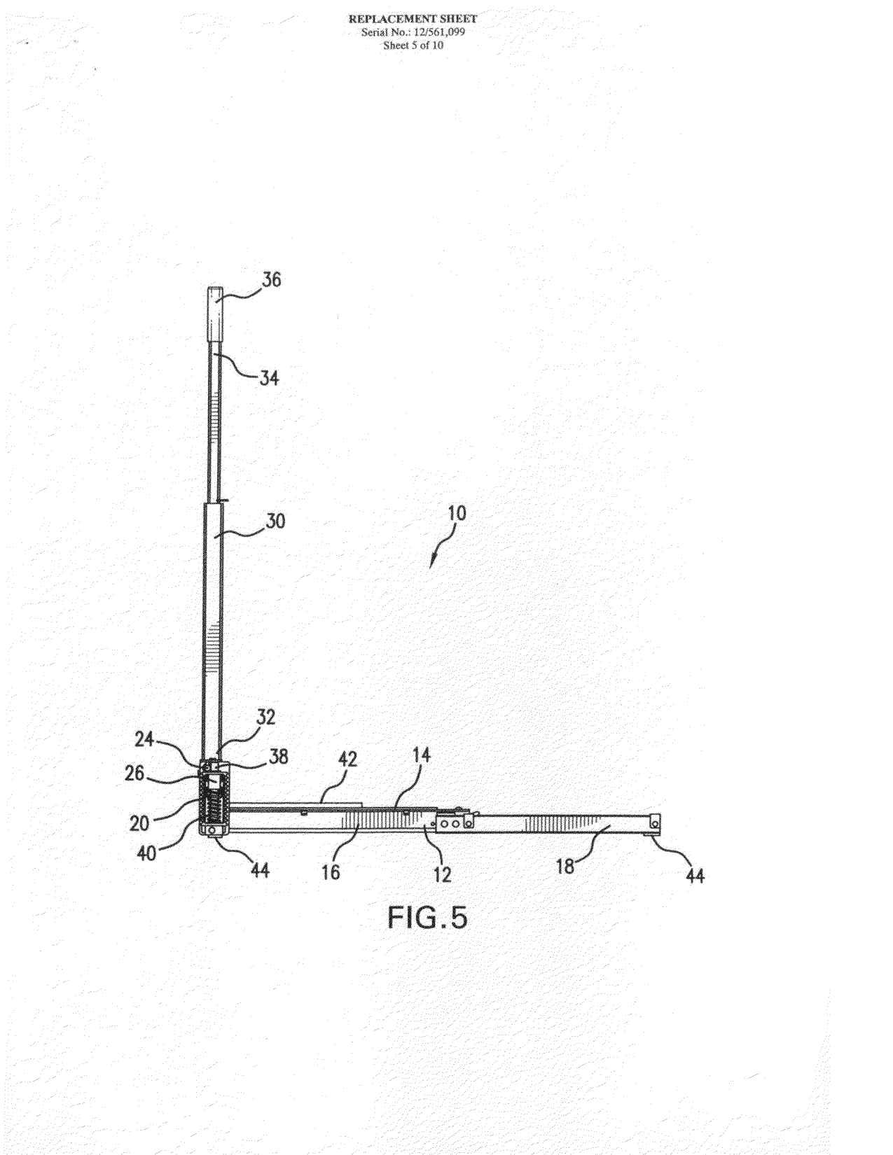

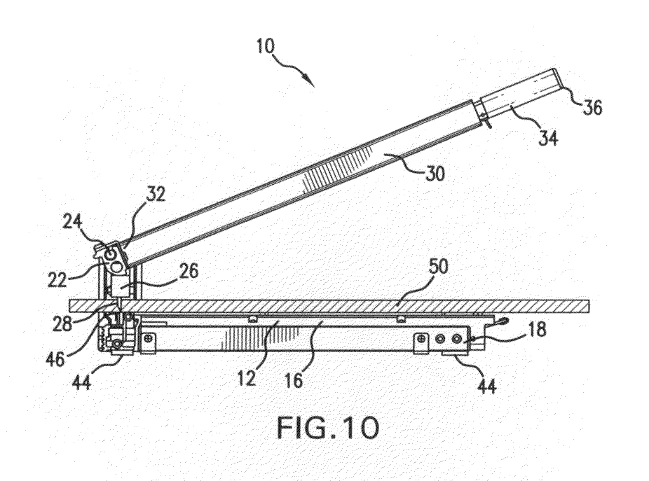

FIGS. 1-10 show a cutting tool 10 according to one embodiment of this invention. The cutting tool 10 as described is preferably used to cut building materials 50 in a predictable and straight fashion without splintering, cracking or similar problems that may arise from such cuts.

As used herein, “material” refers to a sheet or plank of building material, preferably flooring, such as wood flooring, laminate flooring, composite flooring, vinyl flooring, vinyl siding, vinyl composition tile or similar materials, including, but not limited to, one or more combinations of wood, fiber, concrete, plastic and/or other materials that may or may not include a laminated layer.

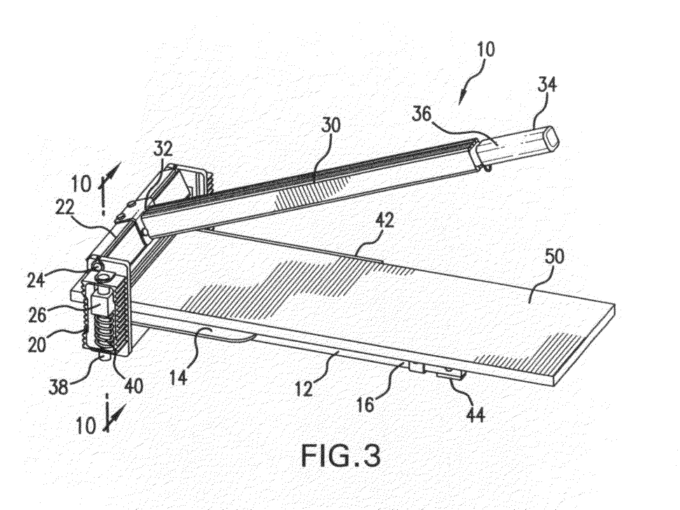

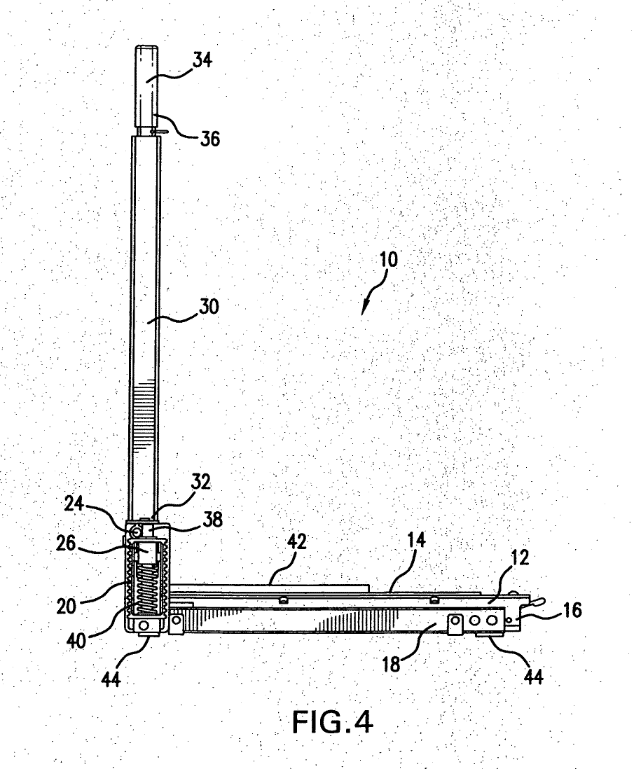

As shown in FIGS. 1-10, the cutting tool 10 includes a base 12. The base 12 may be formed of steel or similar rigid material. The base 10 preferably includes a support surface 14 for accommodating the material 50 to be cut. The base 10 is preferably sized to accommodate standard sizes of material 50, such as flooring, and may correspond in width to such flooring. The base 10 may include a base extension 16 extending beneath at least a portion of the support surface 14 to increase a footprint of the base 10 for increased stability. According to an embodiment of this invention, the base extension 16 can include an extendable portion 18 for extending the footprint of the base 10 longitudinally for stability and support of the material to be cut. Methods for extending the extendable portion can include, but are not limited to, sliding along a rail or pivoting about an axle. FIG. 3 shows a side view of the cutting tool 10 with the extendable portion 18 retracted. Whereas, FIG. 4 shows a side view of the cutting tool 10 with the extendable portion 18 extended, by pivoting about an axle, thereby increasing the footprint of the base 10.

As shown in FIGS. 1-3, a pair of supports 20 are connected to the base 12 extending generally perpendicular to a plane of the support surface 14. In other embodiments, the cutting tool 10 may include a single support. The pair of supports 20 may be formed of materials such as steel or similar rigid material. In FIGS. 1-3, the pair of supports 20 are connected to the base 20 with a nut and bolt and are positioned on either side of the base 12 at a width sufficient to accommodate standard sizes of material, such as flooring, and may correspond in width to such flooring. In other embodiments, the pair of supports 20 can be welded to or integrated with the base 12 or connected in any other means known to one of skill in the art.

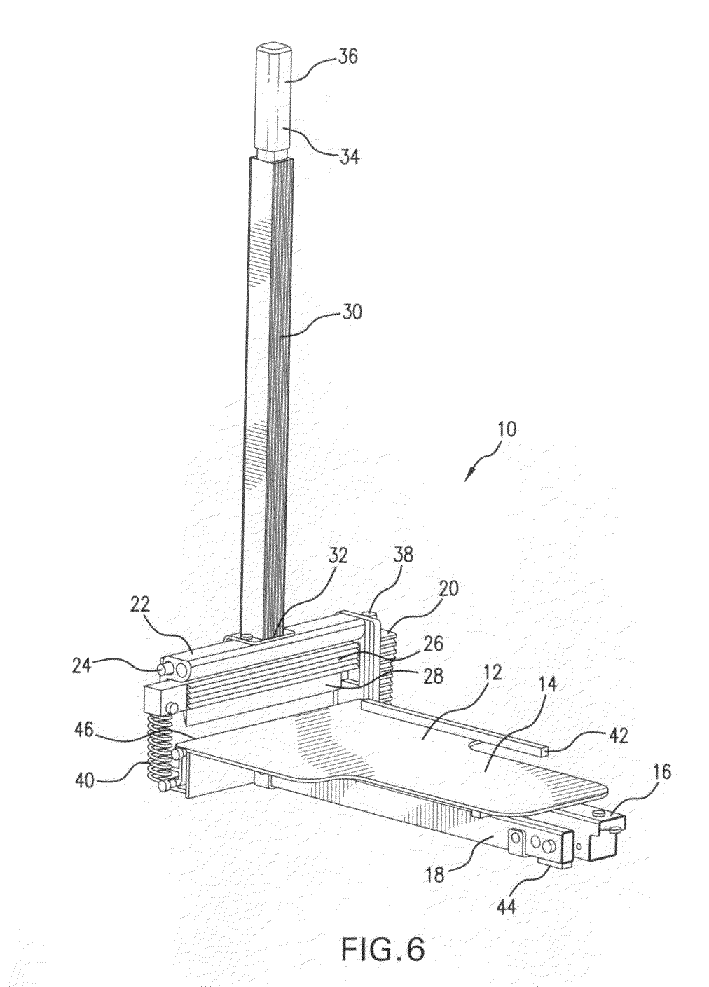

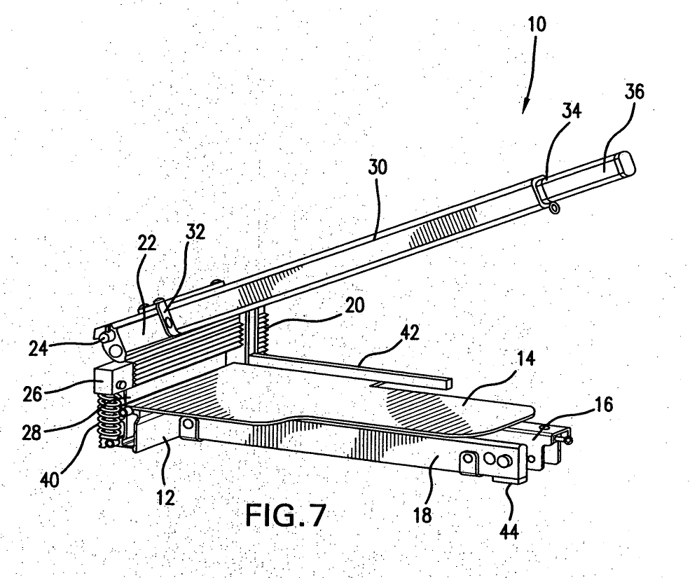

As shown in the figures, a cam 22 is positioned between the pair of supports 20 and over a portion of the base 12. FIGS. 6-7 show, with the support 20 removed, that the cam 22 includes an axle 24. The axle 24 extends through a portion of each of the pair of supports 20 to rotatably connect the cam 22 to the pair of supports 20. The cam 22 further includes an edge with at least two radii and preferably with a gradually increasing radius.

In a preferred embodiment, this invention includes a handle 30 with a proximate end 32 and a distal end 34. The proximate end 32 is attached to the cam 22, to assist a user to rotate the cam 22. This attachment can be formed in various ways including, but not limited to, a threaded connection, a welded connection or by integrating the cam 22 and the handle 30. The distal end 34 preferably includes a hand grip 36 or other portion for the user to manually grab or engage. In a preferred embodiment, the handle 30 may be extendible to provide a longer lever for cutting the material. In the figures of this embodiment, the handle comprises a pair of concentric tubular structures which can be extended by sliding an inner structure out from an outer structure. FIG. 3 shows a side view of the cutting tool 10 with the handle 30 retracted. Whereas, FIG. 4 shows the handle 30 extended thereby increasing leverage for the user. The cutting tool 10 may be highly portable when both the handle 30 and the base 12 are in a fully retracted position as shown in FIG. 3.

FIGS. 6-7 show perspective views of cutting tool 10 with one of the supports removed. As shown in FIGS. 6-7, a blade holder 26 and a blade 28 are positioned between at least a portion of the cam 22 and a portion of the base 12. The blade holder 26 may be formed of a material such as steel or similar rigid material. The blade 28 is preferably formed of a steel material capable of repeatedly cutting all thicknesses and compositions of material. The blade 28 preferably extends transversely relative to the base 12, that is, perpendicular to the lengthwise dimension of the base 12. Actuation of the handle 30 preferably lowers and raises the blade holder 26 and blade 28 from an open position, as shown in FIG. 6, to a closed position, as shown in FIG. 7.

As shown in FIGS. 1-5, the blade holder 26 connects to a guide pin 38 and preferably a pair of guide pins 38, the guide pin 38 extends through a top and/or a bottom of the support 20 to maintain a generally straight path as the blade holder 26 moves from the open position to the closed position. In a preferred embodiment, the guide pin 38 is fixedly connected to the blade holder 26 while extending through both the top and the bottom of the support 20. This preferred embodiment resists lateral movement of the blade holder 26 as the cam 22 slides against a top of the blade holder 26. By resisting the lateral movements, the cutting tool 10 of this invention is less prone to binding as it moves between the open and closed positions. In an alternative embodiment, the guide pin 38 can extend through a portion of the base 12 with or without passing through a portion of the support 20.

According to a preferred embodiment, the blade holder 26 and blade 28 are biased upward into the open position by a spring 40. As shown in the figures, the spring 40 is positioned between a portion of the support 20 and the blade holder 26. In this embodiment, the spring 40 wraps around the guide pin 38. In an alternative embodiment, the spring 40 may be positioned between the blade holder 26 and the base 12 and may or may not wrap around the guide pin 38. As blade holder 26 travels downward, the spring 40 is compressed to further urge a uniform cut of the blade 28 through the material. From device to device, the number of springs 40 may be adjusted depending on the width and thickness of cut desired. The strength and configuration of the spring 40 may be adjusted depending on the desired application.

As shown in FIGS. 1-7, the base 12 preferably includes a guide rail 42 positioned on one side of the support surface 14 perpendicular to a cutting plane of the blade 28. The user can position one edge of the material 50 along the guide rail 42 when making a right angle cut.

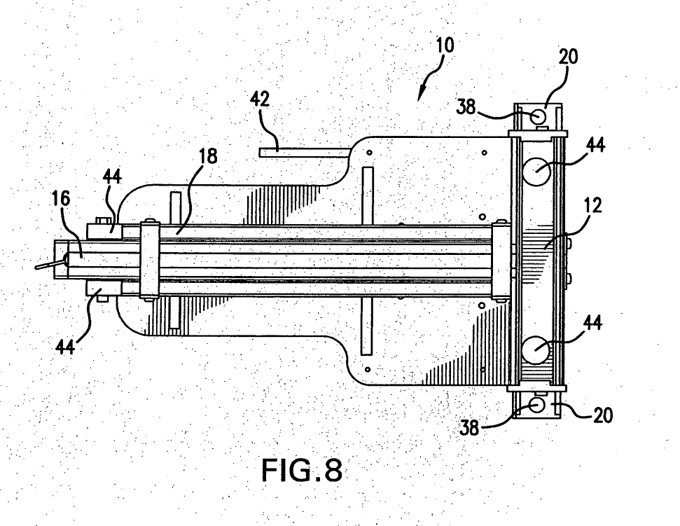

The base 12 may further include one or more support members, such as foot 44 shown in FIG. 8, providing stability to the cutting tool 10 before and during the cutting process. The one or more support members may be integrated with the base 12, or, alternatively, may be attached to the base 12 by screws, welding and/or any other method known to those skilled in the art. In a preferred embodiment, the support members may be adjustable to compensate for an uneven ground surface and to maintain a level support surface 14

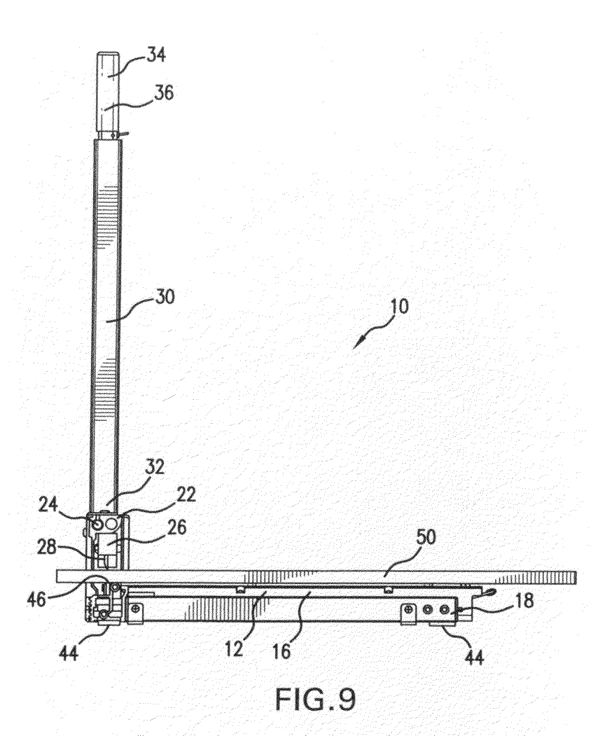

In operation, the cutting tool 10 of this invention starts in the open position as shown in FIG. 9. In the open position, the spring 40 biases the blade holder 26 upward and the cam 22 contacts the blade holder 26 at a relatively small radius, this provides an opening between the blade 28 and a blade stop 46 of the base. A user inserts the material 50 to be cut onto the support surface 14 of the base 10 and through the opening formed between the blade 28 and the base 12. To cut the material, the handle 30 is lowered to rotate the cam 22, as shown in FIG. 9. By rotating the cam 22, a relatively larger radius of the cam 22 contacts the blade holder 26 thereby forcing the blade 28 downward and severing the material 50. The resulting cut is optimally free of splinters and a resulting cut end of the material is otherwise clean and straight.

While in the foregoing specification this invention has been described in relation to certain preferred embodiments thereof, and many details have been set forth for purpose of illustration, it will be apparent to those skilled in the art that the material cutter is susceptible to additional embodiments and that certain of the details described herein can be varied considerably without departing from the basic principles of the invention.

What is claimed is:

1. A cutting tool for cutting a sheet of material, the cutting tool comprising:
a base defining a support surface;
a pair of supports connected to the base;
a cam positioned over a portion of the base, the cam including an axle rotatably connected to each of the pair of supports;
a blade holder with a blade positioned between at least a portion of the cam and a portion of the base, where the blade holder and the blade are movable between an open position and a closed position by pivoting the cam; and
two guide pins connected to the blade holder, each guide pin extending through one of the pair of supports as the blade holder moves from the open position to the closed position.

2. The cutting tool of claim 1, further comprising a handle having a distal end and a proximate end, wherein the proximate end is connected to the cam and the distal end includes a grip.

3. The cutting tool of claim 2, wherein the handle is extendible to provide a longer lever than in a non-extended position.

4. The cutting tool of claim 1, wherein the base further comprises a base extension extending beneath at least a portion of the support surface.

5. The cutting tool of claim 4, wherein the base extension is extendible to provide the base a larger footprint.

6. The cutting tool of claim 1, further comprising a spring positioned between the blade holder and one of the base or the support, the spring biasing the blade holder to the open position.

7. The cutting tool of claim 1, further comprising a guide rail positioned on the support surface.

8. The cutting tool of claim 1, wherein the base further comprises an adjustable foot.

9. The cutting tool of claim 1, wherein the base further comprises a blade stop.

10. A cutting tool for cutting a sheet of material, the cutting tool comprising:
a base defining a support surface;
a pair of supports connected to the base;
a cam including an edge with a small radius and a large radius, the cam positioned over a portion of the base, the cam further including an axle rotatably connected to each of the pair of supports;
a blade holder including a blade in contact with the cam, wherein the blade holder and the blade are in an open position when the small radius of the cam contacts the blade holder and wherein the blade holder and the blade are in a closed position when the large radius of the cam contacts the blade holder.

11. The cutting tool of claim 10, further comprising a handle having a distal end and a proximate end, wherein the proximate end is connected to the cam and the distal end includes a grip.

12. The cutting tool of claim 11, wherein the handle is extendible to provide a longer lever than in a non-extended position.

13. The cutting tool of claim 10, wherein the base further comprises a base extension extending beneath at least a portion of the support surface.

14. The cutting tool of claim 13, wherein the base extension is extendible to provide the base a larger footprint.

15. The cutting tool of claim 10, further comprising a guide pin connected to the blade holder, the guide pin extending through at least one of the base or the support as the blade holder moves from the open position to the closed position.

16. The cutting tool of claim 15, further comprising a spring positioned between the blade holder and one of the base or the support, the spring biasing the blade holder to the open position.

17. The cutting tool of claim 10, further comprising a guide rail positioned on the support surface.

18. The cutting tool of claim 10, wherein the base further comprises an adjustable foot.

19. The cutting tool of claim 10, wherein the base further comprises a blade stop.
